(19) United States
(12) Patent Application Publication
(10) Pub. No.: US 2025/0154904 A1
(43) Pub. Date: May 15, 2025

(54) FUEL CONTROL SYSTEM

(71) Applicant: Safran Aircraft Engines, Paris (FR)

(72) Inventors: Huguette DE WERGIFOSSE, MOISSY-CRAMAYEL (FR); Loïc PORA, MOISSY-CRAMAYEL (FR)

(73) Assignee: Safran Aircraft Engines, Paris (FR)

(21) Appl. No.: 18/839,134

(22) PCT Filed: Feb. 16, 2023
(86) PCT No.: PCT/FR2023/050210

§ 371 Date: Aug. 16, 2024

(30) Foreign Application Priority Data
Feb. 18, 2022 (FR) FR2201480

(51) Int. Cl. F02C 7/22; F02C 7/32; F04D 1/00; F04D 13/14; F23R 3/28

(52) U.S. Cl. CPC F02C 7/22; F02C 7/32; F04D 1/00; F04D 13/14; F23R 3/28; F05D 2260/4031

(57) ABSTRACT

The present invention relates to a fuel control system (4) comprising: a fuel source; a supply conduit; a main circuit comprising: a first centrifugal pump; a connecting conduit; a second centrifugal pump; a discharge conduit; and a secondary circuit.

### FIELD OF THE INVENTION

The present invention relates to the aeronautical field. More precisely, the present invention relates to the control of fuel within an aircraft engine.

### BACKGROUND

The control of fuel within an aircraft engine is generally provided by a system comprising a positive displacement pump driven by a rotating spool of the engine. Replacing the positive displacement pump with a centrifugal pump could procure certain advantages; in particular this would allow the fuel control system to increase its durability. However, a centrifugal pump has certain disadvantages; in particular, its efficiency depends on the flow rate of fuel that it delivers.

### SUMMARY

One object of the invention is to improve a fuel control system for an aircraft engine comprising at least one centrifugal pump.

To this end, a fuel control system for an aircraft engine is proposed, according to one aspect of the invention, the system comprising:
a fuel source;
a feed line connected to the fuel source;
a main circuit comprising:
   a first centrifugal pump comprising an intake port and a discharge port, the intake port being connected to the feed line;
   a connecting line connected to the discharge port of the first centrifugal pump;
   a second centrifugal pump comprising an intake port and a discharge port, the intake port of the second centrifugal pump being connected to the connecting line;
   a discharge line connected to the discharge port of the second centrifugal pump, the discharge line also being configured to be connected to an injector of a combustion chamber of the engine; and
a secondary circuit comprising at least one member configured to be actuated by a pressure of the fuel circulating within the secondary circuit, the secondary circuit comprising an intake line connected to the discharge line and an output line connected to the connecting line.

Advantageously but optionally, the system according to the invention can comprise at least one of the following features, taken alone or in combination:
the first centrifugal pump and the second centrifugal pump are configured so that, in operation, the first centrifugal pump supplies a first pressure and the second centrifugal pump supplies a second pressure, the first pressure being less than the second pressure;
the first centrifugal pump and the second centrifugal pump are configured so that, in operation, the first centrifugal pump delivers a first fluid flow rate solely dedicated to feeding the combustion chamber, and the second centrifugal pump delivers a second fluid flow rate dedicated both to feeding the combustion chamber and to actuating the at least one member, the first flow rate being less than the second flow rate;
the main circuit also comprises a restriction arranged at the discharge line and configured to control the flow rate of the fuel discharged by the second centrifugal pump;
the at least one member is a variable geometry unit;
each of the first centrifugal pump and the second centrifugal pump comprises a rotor portion and a stator portion, the rotor portion of the first centrifugal pump being integral in rotation with the rotor portion of the second centrifugal pump; and
each of the first centrifugal pump and the second centrifugal pump comprises a rotor portion and a stator portion, the stator portion of the first centrifugal pump being mounted fixedly on the stator portion of the second centrifugal pump.

According to another aspect, the invention relates to an aircraft engine comprising:
a system as previously described;
an electric motor comprising a rotating element connected to at least one of the rotor portion of the first centrifugal pump and the rotor portion of the second centrifugal pump to drive it in rotation relative to the stator portion;
an electrical power source connected to the electric motor to transmit electrical power to it in order to drive the rotating element in rotation; and
a combustion chamber comprising an injector connected to the discharge line to receive fuel from the second centrifugal pump.

According to another aspect, the invention relates to an aircraft engine comprising:
a system as previously described;
an accessory gearbox comprising a rotating element connected to at least one of the rotor portion of the first centrifugal pump and the rotor portion of the second centrifugal pump to drive it in rotation relative to the stator portion;
a rotating spool connected to the accessory gearbox to drive the rotating element in rotation; and
a combustion chamber comprising an injector connected to the discharge line to receive fuel from the second centrifugal pump.

According to another aspect, the invention relates to an aircraft comprising an aircraft engine as previously described.

### DESCRIPTION OF THE DRAWINGS

Other features, objectives and advantages of the invention will be revealed by the description that follows, which is purely illustrative and not limiting, and which must be read with reference to the appended drawings in which:

FIG. 1 illustrates an aircraft schematically.

FIG. 2 is a schematic section view of a propulsion assembly for an aircraft.

FIG. 3 illustrates schematically a fuel control system according to one embodiment of the invention.

FIG. 4 illustrates the pressure/flow rate characteristic, for two distinct operating conditions, of each of the two centrifugal pumps of a fuel control system according to one embodiment of the invention.

FIG. 5 illustrates the efficiency/flow rate characteristic for each of the two operating conditions of each of the two centrifugal pumps the pressure/flow rate characteristic of which is illustrated in FIG. 4.

In all the drawings, similar elements bear identical labels.

### DETAILED DESCRIPTION OF THE INVENTION

### Aircraft

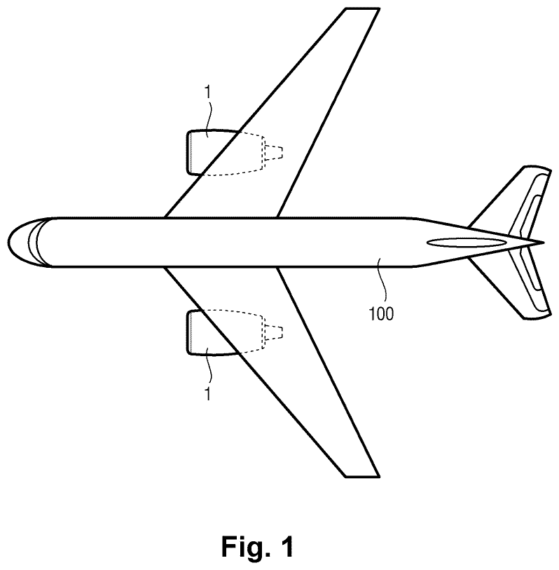

FIG. 1 illustrates an aircraft 100 comprising at least one propulsion assembly 1, in this case two propulsion assemblies 1. The aircraft 100 shown is an airplane, civil or military, but could be any other type of aircraft 100, such as a helicopter. The propulsion assemblies 1 are applied and attached to the airplane 100, each under one wing of the airplane 100, as can be seen in FIG. 1. This is not, however, limiting, because at least one propulsion assembly 1 can also be mounted on the wing of the airplane or even at the rear of its fuselage.

### Propulsion Assembly

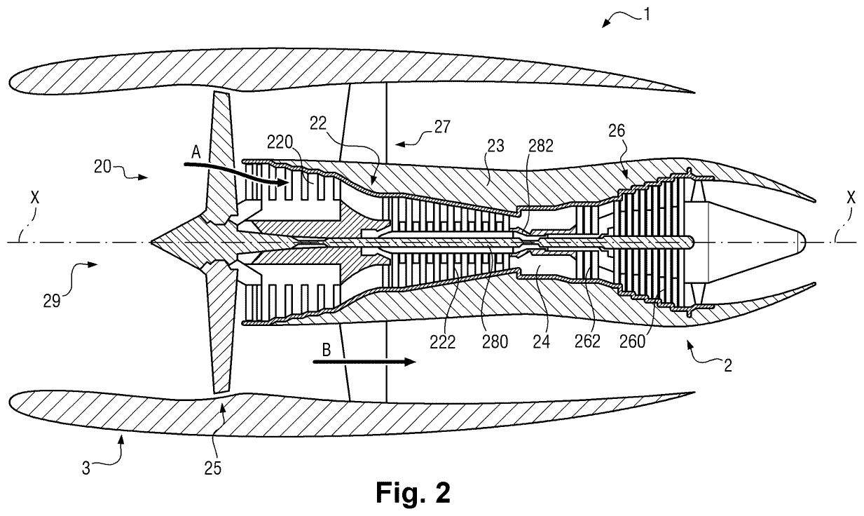

FIG. 2 illustrates a propulsion assembly 1 having a longitudinal axis X-X, and comprising an engine 2 (or turbomachine) and a nacelle 3 surrounding the engine 2.

The propulsion assembly 1 is intended to be mounted on an aircraft 100, in the manner illustrated in FIG. 1 for example. In this regard, the propulsion assembly 1 can comprise a pylon (not shown) intended to connect the propulsion assembly 1 to a portion of the aircraft 100.

The engine 2 illustrated in FIG. 2 is a two spool, double flow, direct drive turbojet. This, however, is not limiting because the engine 2 can include a different number of spools and/or of flows, and/or be another type of turbojet, such as a turbojet with a reduction gear or a turboprop.

Unless otherwise stated, the terms “upstream” and “downstream” are used with reference to the overall air flow direction through the propulsion assembly 1 in operation. Likewise, an axial direction corresponds to the direction of the longitudinal axis X-X and a radial direction is a direction perpendicular to the longitudinal axis X-X and intersecting the longitudinal axis X-X. Moreover, an axial plane is a plane containing the longitudinal axis X-X and a radial plane is a plane perpendicular to the longitudinal axis X-X. A circumference is understood to be a circle belonging to a radial plane, the center of which belongs to the longitudinal axis X-X. A tangential or circumferential direction is a direction tangent to a circumference: it is perpendicular to the longitudinal axis X-X but does not pass through the longitudinal axis X-X. Finally, the adjectives “interior” (or “internal”) “exterior” (or “external”) are used with reference to a radial direction so that the interior portion of an element is, in a radial direction, closer to the longitudinal axis X-X than the exterior portion of the same element.

As can be seen in FIG. 2, the engine 2 comprises, from upstream to downstream, a fan 20, a compression section 22 comprising a low-pressure compressor 220 and a high-pressure compressor 222, a combustion chamber 24 and an expansion section 26 comprising a high-pressure turbine 262 and a low-pressure turbine 260. The combustion chamber 24 comprises a fuel injection ramp (not shown) and a plurality of ignition injectors (not shown). The injection ramp and/or the ignition injectors constitute the main fuel-consuming members of the engine 2. The fan 20, the rotor portion of the low-pressure compressor 220, and the rotor portion of the low-pressure compressor 260 are linked together by a low-pressure shaft 280 extending along the longitudinal axis X-X, the fan 20, the low-pressure compressor 220 and the low-pressure turbine 260 then forming a low-pressure spool 20, 220, 260, 280, which is a first rotating spool. The rotor portion of the high-pressure compressor 222 and the rotor portion of the high-pressure turbine 262 are linked together by a high-pressure shaft 282 extending along the longitudinal axis X-X, the high-pressure compressor 222 and the high-pressure turbine 262 then forming a high-pressure spool 222, 262, 282, which is a second rotating spool. As can be seen in FIG. 2, the compression section 22, the combustion chamber 24 and the expansion section 26 are surrounded by an engine casing 23, while the fan 20 is surrounded by a fan casing 25. The engine casing 23 and the fan casing 25 are linked together by profiled structural arms forming straighteners (or OGV for “Outlet Guide Vanes”) distributed circumferentially all around the longitudinal axis X-X. The longitudinal axis X-X forms the axis of rotation for the fan 20, the rotor portion of the compression section 22 and the rotor portion of the expansion section 26, i.e. for the low-pressure spool 20, 220, 260, 280 and the high-pressure spool 222, 262, 282, which are able to be driven in rotation around the longitudinal axis X-X relative to the engine casing 23 and to the fan casing 25.

The engine 2 can also comprise at least one accessory gearbox (not shown), called an AGB, housed for example in a cavity provided within the nacelle 3. The accessory gearbox comprises a set of rotating elements, such as gears, allowing a plurality of shafts to be driven in rotation around their own axis, accessories being mounted on these shafts to draw useful mechanical power from their rotation. The gear assembly is itself driven by means of a power takeoff shaft connecting, possibly by means of a transfer case (not shown), the accessory gearbox to at least one of the high-pressure spool 222, 262, 282 and the low-pressure spool 20, 220, 260, 280, typically by being meshed with at least one of the high-pressure shaft 282 and the low-pressure shaft 280. In this regard, the power takeoff shaft can extend inside a longitudinal cavity provided within one of the structural arms 27. In this manner, mechanical power can be extracted from one at least of the high-pressure spool 222, 262, 282 and the low-pressure spool 20, 220, 260, 280 to be delivered to one at least of the accessories by means of the accessory gearbox.

The engine 2 comprises a certain number of members (or units) configured to be actuated by means of fuel. More precisely, these members are hydraulically actuated and provision is made to use fuel under pressure to provide their operation. These members are customarily designated under the title “variable geometry units (or accessories) 4200” or, more simply, “variable geometries 4200.” Some examples of variable geometries 4200 are: variable pitch blades (e.g., stator blades of the high-pressure compressor 222), primary stream A or secondary stream B discharge valves. These variable geometries 4200 therefore need pneumatic energy linked to the fuel pressure to operate. Nevertheless, unlike an injector (for ignition or for the injection ramp) of the combustion chamber, the variable geometries 4200 do not consume fuel, because they do not degrade it by combustion.

The nacelle 3 extends radially outside the engine 2, all around the longitudinal axis X-X, so as to surround both the fan casing 25 and the engine casing 23, and to define, with a portion downstream of the engine casing 23, a downstream portion of a secondary stream B, the upstream portion of the secondary stream B being defined by the fan casing 25 and an upstream portion of the engine casing 23. The upstream portion of the nacelle 3 also defines an air intake 29 through which the fan 20 draws in the flow of air circulating through the propulsion assembly 1. The nacelle 3 is integral with the fan casing 25 and applied and attached to the aircraft 100 by means of the pylon.

In operation, the fan 20 draws in a flow of air of which a portion, circulating within a primary stream A passing through the engine casing 23 from end to end, is successively compressed within the compression section 22, ignited within the combustion chamber 24 by combustion of fuel, and expanded within the expansion section 26 before being ejected out of the engine 2. Another portion of the flow of air circulates within the second stream B which takes on an extended annular shape surrounding the engine casing 23, the air drawn in by the fan 20 being straightened by the straighteners 27 then ejected out of the propulsion assembly 1. In this manner, the propulsion assembly 1 generates a thrust. This thrust can, for example, be used for the benefit of the aircraft 100 to which the propulsion assembly 1 is applied and attached.

### Fuel Control System

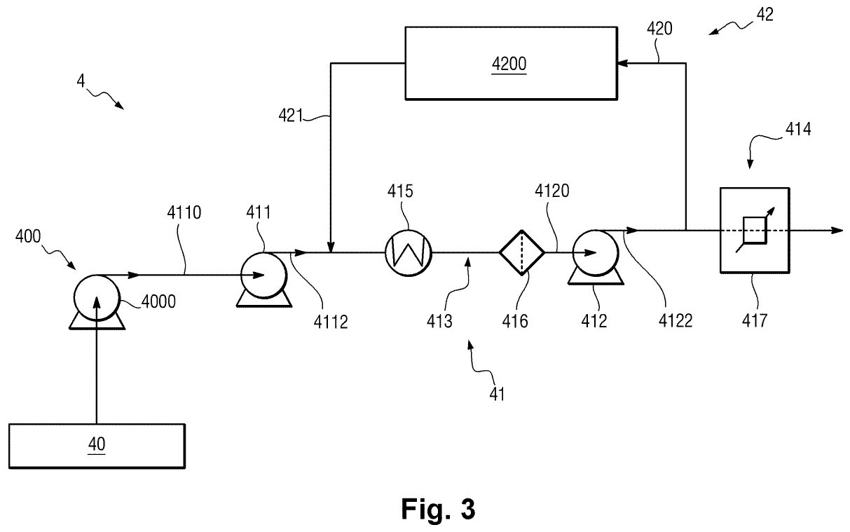

For the purpose of simultaneously feeding the fuel consuming members, such as the injectors (ignition or injection ramp) of the combustion chamber 24, and the variable geometries 4200, the engine 2 comprises a fuel control system 4, illustrated in FIG. 3.

The fuel control system 4 comprises a fuel source 40, such as a reservoir, containing the fuel intended for the operation of the variable geometries 4200 and for combustion within the combustion chamber 24. In addition, a feed line 400 is connected to the fuel source 40.

As illustrated by FIG. 3, the fuel control system 4 comprises a main circuit 41 and a secondary circuit 42, the secondary circuit 42 being connected to the main circuit 41, which is connected to the fuel source 40 by means of the feed line 400.

Advantageously, a centrifugal booster pump 4000 is interposed between the fuel source 40 and the main circuit 41, on the feed line 400, for the pressurization of the main circuit 41 and of the secondary circuit 42.

The main circuit 41 comprises a certain number of members mounted in series, among them a first centrifugal pump 411 and a second centrifugal pump 412. Each of the first centrifugal pump 411 and second centrifugal pump 412 comprises an intake port 4110, 4120 and a discharge port 4112, 4122. In addition, a connecting line 413 connects the discharge port 4112 of the first centrifugal pump 411 to the intake port 4120 of the second centrifugal pump 412, so that all of the fluid discharged by the first centrifugal pump 411 is taken in by the second centrifugal pump 412.

The first centrifugal pump 411 is arranged so that its intake port 4110 is connected to the feed circuit 400 to take in fuel from the fuel source 40, possibly previously pressurized by the booster pump 4000.

As can be seen in FIG. 3, the main circuit 41 also comprises a discharge line 414 connected to the discharge port 4122 of the second centrifugal pump 412 and to a fuel-consuming member, such as an injector of the combustion chamber 2, so that the latter receives fuel from the second centrifugal pump 412. Thus at least one portion of the fuel discharged by the second centrifugal pump 412 can be taken in within the combustion chamber 24, to be mixed with air originating in the compression section 22, in order to be ignited.

Advantageously, the main circuit 41 comprises a heat exchanger 415 and/or a filter 416, positioned on the connecting line 413, between the discharge port 4112 of the first centrifugal pump 411 and the intake port 4120 of the second centrifugal pump 412. The filter 416 allows treating the fuel circulating within the fuel control system 4 in order to optimize its operation. In addition, the heat exchanger 415 allows cooling the oil circuit of the enclosures of the engine 1, in contact with which the fuel circulates, the fuel control system then being considered as a cold source capable of absorbing calories.

Advantageously, the main circuit 41 also comprises a restriction 417 arranged at the discharge line 414 and configured to control the flow rate of fuel discharged by the second centrifugal pump 412. More precisely, the restriction 417 is configured to generate in-line losses (or head losses), of a thermal nature, within the discharge line 414, which allows adjusting the flow rate of fuel within the line connecting the discharge line 414 to the injectors of the combustion chamber 24. The restriction 417 can be a variable-cross-section valve controlled by a servo-valve.

The secondary circuit 42 is arranged in parallel with the main circuit 41, more precisely in parallel with the second centrifugal pump 412, advantageously also in parallel with the heat exchanger 415 and with the filter 416. In this regard, the secondary circuit 42 comprises an intake line 420 connected to the discharge line 414 and an output line 421 connected to the connecting line 413.

In addition, the secondary circuit 42 comprises at least one variable geometry 4200, which is thus fed by at least one portion of the fuel discharged by the second centrifugal pump 412. After having passed through the variable geometry 4200, the fuel is then discharged into the connecting line 413 so that a portion of the fuel taken in by the second centrifugal pump 412 has, in fact, circulated through the variable geometries 4200. In other words, a portion of the fuel taken in by the second centrifugal pump 412 is discharged by the first centrifugal pump 411, the rest having circulated within the secondary circuit 42. In addition, a portion of the fuel discharged by the second centrifugal pump 412 circulates within the secondary circuit 42, the rest being burned within the combustion chamber 24.

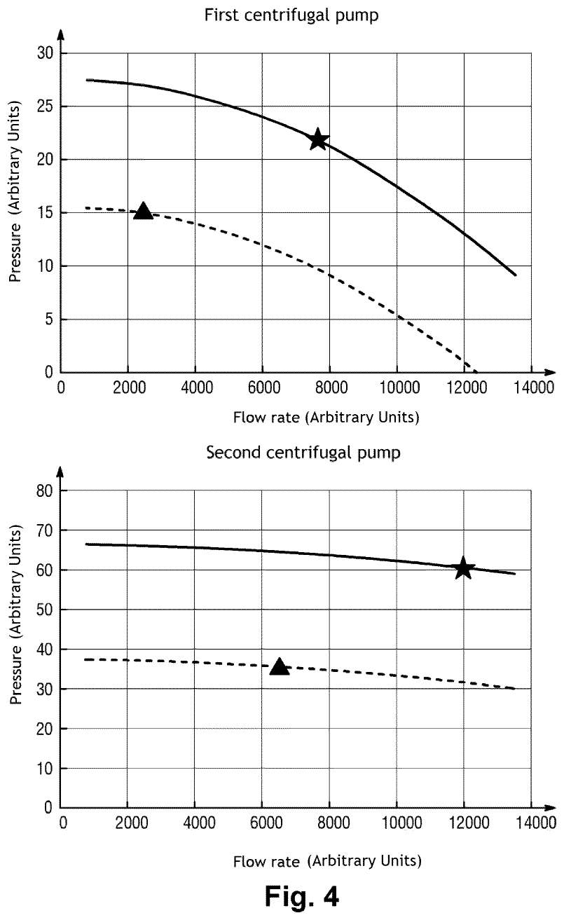

Each of the first centrifugal pump 411 and of the second centrifugal pump 412 comprises a rotor portion and a stator portion, the rotor portion being movable relative to the stator portion, typically by rotation of an input shaft of the centrifugal pump 411, 412 around its own axis. Generally, each of the first centrifugal pump 411 and of the second centrifugal pump 412 is a rotary machine which pumps the fuel by forcing it through a bladed wheel, or a propeller, generally called an “impeller,” which is integral with the shaft and forms, with the shaft, the rotor portion. The impeller is housed within a casing of the centrifugal pump 411, 412, which forms the stator portion. Due to the effect of the rotation of the impeller, the pumped fuel is taken up axially into the centrifugal pump 411, 412, i.e. in a direction parallel to the axis of the shaft, then accelerated radially, i.e. in a direction perpendicular to the axis of the shaft, and finally discharged tangentially, i.e. in a direction tangential to the axis of the shaft. The centrifugal booster pump 4000 advantageously has the same structure as that of each of the first centrifugal pump 411 and of the second centrifugal pump 412. Either way, it should be noted that, unlike a positive-displacement pump which is a flow rate source, a centrifugal pump 411, 412, 4000 is a pressure source. In fact, a centrifugal pump 411, 412, 4000 is configured so that, in operation, it can deliver a fuel flow rate which is variable, because it depends on the speed of rotation of its rotor portion relative to its stator portion, but with an increase in pressure between the intake port 4110, 4120 and the discharge port 4112, 4122 which remains constant, or practically constant, regardless of the flow rate, as can be seen in particular in FIG. 4.

Advantageously, the rotor portion of the first centrifugal pump 411 is integral in rotation with the rotor portion of the second centrifugal pump 412. Typically, the input shaft of the first centrifugal pump 411 is common with the input shaft of the second centrifugal pump 412.

Also advantageously, the stator portion of the first centrifugal pump 411 is mounted fixedly on the stator portion of the second centrifugal pump 412. Typically, the casing of the first centrifugal pump 411 is mounted fixedly on the casing of the second centrifugal pump 412.

The driving in rotation of the rotor portion, relative to the stator portion, of each of the first centrifugal pump 411 and of the second centrifugal pump 412, can be implemented in different ways.

In one variant, the aircraft 100 engine 2 comprises an electric motor (not shown), which can be synchronous or asynchronous, and which comprises a rotating element, typically an output shaft, connected to at least one of the rotor portion of the first centrifugal pump 411 and the rotor portion of the second centrifugal pump 412 to drive it in rotation relative to the stator portion. In addition, the aircraft 100 engine 2 comprises an electrical power source, typically a battery or a generator driven by at least one of the high-pressure spool 222, 262, 282 and the low-pressure spool 20, 220, 260, 280, the electrical power source being connected to the electric motor to transmit electrical power to it in order to drive the rotating element of the electric motor in rotation. The use of an electric motor allows each of the first centrifugal pump 411 and the second centrifugal pump 412, to deliver the necessary fuel flow rate, particularly to the variable geometries 4200, this even at low driving speeds of the rotating spools 20, 22, 26. In fact, an electric motor can drive each of the first centrifugal pump 411 and the second centrifugal pump 412 at high speeds of rotation, even at low driving speeds of the rotating spools 20, 22, 26, because the driving speed of the electric motor is not linked to the speed of rotation of the rotating spools 20, 22, 26. This being the case, it is not necessary to over-dimension the centrifugal pumps 411, 412 to be able to respond to fuel flow rate needs at low driving speeds of the rotating spools 20, 22, 26, particularly as regards the variable geometries 4200. Moreover, the use of the electric motor also allows optimizing the power extracted from the rotating spools 20, 22, 26, if necessary.

In another variant, a gear train of the accessory gear box is connected to at least one of the rotor portion of the first centrifugal pump 411 and the rotor portion of the second centrifugal pump 412 to drive it in rotation relative to the stator portion. In this other variant, it can be useful to provide an auxiliary member connected to the main circuit 41 to supply sufficient fuel pressure, both in the secondary circuit 42 and in the discharge line 414, at low operating speeds of the rotating spools 20, 22, 26.

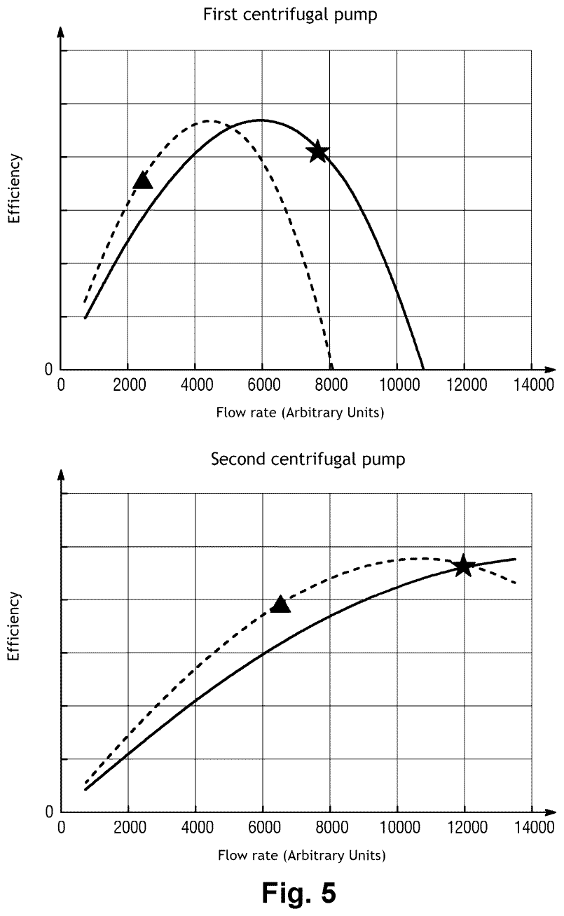

FIG. 4 and FIG. 5 illustrate characteristics of the centrifugal pumps 411, 412 for two distinct operating speeds, one illustrated by a solid line, the other by a dotted line.

FIG. 4 shows, for each of the first centrifugal pump 411 and the second centrifugal pump 412, the evolution of the differential pressure (i.e., the difference between the fuel pressure at the discharge port 4112, 4122 and the fuel pressure at the intake port 4110, 4120) as a function of the flow rate of fuel discharged by the centrifugal pump 411, 412. As can be seen in FIG. 4, this evolution is different depending on the operating speed of the centrifugal pump 411, 412, i.e. depending on the driving speed of the rotor portion of the pump relative to its stator portion.

FIG. 5 shows, for each of the first centrifugal pump 411 and the second centrifugal pump 412, the evolution of the efficiency of the centrifugal pump 411, 412 as a function of the flow rate of fuel discharged by the centrifugal pump 411, 412, for the same operating speeds as those illustrated in FIG. 4. There too, FIG. 5 illustrates that this evolution is different depending on the operating speed of the centrifugal pump 411, 412.

To optimize the efficiency of the fuel control system 4, it should be made to operate so as to unbalance the first centrifugal pump 411 relative to the second centrifugal pump 412. More exactly, each of the first centrifugal pump 411 and the second centrifugal pump 412, should be configured, then made to operate so that, regardless of their speed, the first pump 411 delivers a flow rate that is smaller than the flow rate delivered by the second centrifugal pump 412 and introduces an increase in fuel pressure in the main circuit 41 which is less than the pressure increase introduced by the second centrifugal pump 412 in the main circuit 41. In this configuration the flow rate of fluid delivered by the first centrifugal pump 411 is in fact solely dedicated to feeding the combustion chamber 24, while the flow rate of fluid delivered by the second centrifugal pump 412 is, for its part, dedicated both to feeding the combustion chamber 24 and the actuation of the variable geometries 4200.

This is particularly visible in FIG. 4 and in FIG. 5, in which the triangle marks the point of operation of each of the first centrifugal pump 411 and the second centrifugal pump 412 when the aircraft 100 is cruising, while the star marks the point of operation of each of the first centrifugal pump 411 and the second centrifugal pump 412 when the aircraft 100 is taking off. Each of these points of operation corresponds to different speeds of the first centrifugal pump 411 and of the second centrifugal pump 412, the operating speed associated with takeoff being illustrated by the solid line curve, while the operating speed associated with cruise is illustrated with dotted lines.

### Advantages Obtained

Generally, centrifugal pumps are more robust and more compact than positive-displacement pumps.

On the other hand, the efficiency of centrifugal pumps depends on their operating point and can become very low if they operate far from the operating point where the efficiency is a maximum, as can be seen in FIG. 5.

Due to the fuel control system, in which the centrifugal pumps can be unbalanced, i.e. operate at different pressures and flow rates, each of the centrifugal pumps operating near its maximum efficiency, the entire range of operation of the engine can be covered without it being necessary to dimension one and/or the other of the centrifugal pumps at the performance level of the engine imposing the highest constraints on the fuel control system. In fact, regardless of the engine speed considered, the centrifugal pumps will always operate at their maximum efficiency.

In addition, due to the centrifugal pumps, it is not necessary to provide a speed reducer between an electric motor and the pump feeding a fuel control system of an aircraft engine, which allows reducing the mass of the engine. As a matter of fact, unlike positive-displacement pumps, centrifugal pumps can be driven at higher speeds, which minimizes the size of the electric motor.

Moreover, due to the configuration and to the method of operation of each of the first pump and of the second pump, but also to the arrangement of the secondary circuit relative the main circuit, it is the second centrifugal pump which delivers the surplus fuel flow rate that is useful to the variable geometries, while the flow rate of fuel transferred to the injectors of the combustion chamber is, in fact, delivered by the first centrifugal pump. In addition, it is the second centrifugal pump which supplies the necessary pressure for the actuation of the variable geometries, the pressure required by the injectors being linked to the sum of the pressure supplied by the first centrifugal pump and the pressure supplied by the second centrifugal pump.

The benefits of this configuration and of this method of operation of each of the first pump and the second pump are also visible in FIG. 5. In fact, as can be seen in this figure, for each operating speed described with reference to FIG. 4, the operating point of the first pump and of the second pump, still illustrated respectively by the triangle for cruise and by the star for takeoff, is close to the maximum efficiency of the centrifugal pump corresponding to this operating speed, and are identical, or practically identical, for both centrifugal pumps. More exactly, the efficiency of the fuel control system, taken as a whole, remains constant, or practically constant, regardless of the operating speed of the aircraft. In conclusion, this configuration makes it possible to attain optimal efficiency with a system equipped with a dual centrifugal pump.

Finally, even in the embodiments in which a restriction is necessary, this dissipates less energy in the form of heat than when a positive displacement pump is used. The unbalance of the first centrifugal pump relative to the second centrifugal pump is more relevant if the pressure required by the variable geometries is not too high.

In fact, the pressure supplied by the second centrifugal pump is keyed to the value required by the variable geometries, without being over-dimensioned, this regardless of the operating speed.

Thus, an optimization of the size and of the mass of the centrifugal pumps, of the overall efficiency of the system and, if possible, of the size and of the mass of the electric motor, are advantageously obtained.

1-10. (canceled)

11. A fuel control system comprising:
a fuel source;
a feed line connected to the fuel source;
a main circuit comprising:
a first centrifugal pump comprising an intake port and a discharge port, the intake port being connected to the feed line;
a connecting line connected to the discharge port of the first centrifugal pump;
a second centrifugal pump comprising an intake port and a discharge port, the intake port of the second centrifugal pump being connected to the connecting line;
a discharge line connected to the discharge port of the second centrifugal pump, the discharge line being configured to be further connected to an injector of a combustion chamber of an aircraft engine; and
a secondary circuit comprising at least one member configured to be actuated by a pressure of a fuel circulating within the secondary circuit, the secondary circuit comprising an intake line connected to the discharge line of the main circuit and an output line connected to the connecting line of the main circuit.

12. The fuel control system of claim 11, wherein the first centrifugal pump and the second centrifugal pump of the main circuit are configured so that, in operation, the first centrifugal pump supplies a first pressure and the second centrifugal pump supplies a second pressure, the first pressure being less than the second pressure.

13. The fuel control system of claim 11, wherein the first centrifugal pump and the second centrifugal pump of the main circuit are configured so that, in operation, the first centrifugal pump delivers a first fluid flow rate solely dedicated to feeding the combustion chamber and the second centrifugal pump delivers a second fluid flow rate dedicated both to feeding the combustion chamber and to actuating the at least one member of the secondary circuit, the first flow rate being less than the second flow rate.

14. The fuel control system of claim 11, wherein the main circuit further comprises a restriction arranged at the discharge line of the main circuit and configured to control a flow rate of a fuel discharged by the second centrifugal pump of the main circuit.

15. The fuel control system of claim 11, wherein the at least one member of the secondary circuit is a variable geometry unit.

16. The fuel control system of claim 11, wherein each of the first centrifugal pump and the second centrifugal pump of the main circuit comprises a rotor portion and a stator portion, the rotor portion of the first centrifugal pump being integral in rotation with the rotor portion of the second centrifugal pump.

17. The fuel control system of claim 11, wherein each of the first centrifugal pump and the second centrifugal pump of the main circuit comprises a rotor portion and a stator portion, the stator portion of the first centrifugal pump being mounted fixedly on the stator portion of the second centrifugal pump.

18. An aircraft engine comprising:
the fuel control system of claim 16;
an electric motor comprising a rotating element connected to at least one of the rotor portion of the first centrifugal pump and the rotor portion of the second centrifugal pump to drive the rotating element in rotation relative to at least one of the stator portion of the first centrifugal pump and the stator portion of the second centrifugal pump;
an electrical power source connected to the electric motor to transmit electrical power to the electric motor in order to drive the rotating element in rotation; and
a combustion chamber comprising an injector connected to the discharge line of the main circuit to receive fuel from the second centrifugal pump of the main circuit.

19. An aircraft engine comprising:
the fuel control system of claim 17;
an electric motor comprising a rotating element connected to at least one of the rotor portion of the first centrifugal pump and the rotor portion of the second centrifugal pump to drive the rotating element in rotation relative to at least one of the stator portion of the first centrifugal pump and the stator portion of the second centrifugal pump;
an electrical power source connected to the electric motor to transmit electrical power to the electric motor in order to drive the rotating element in rotation; and
a combustion chamber comprising an injector connected to the discharge line of the main circuit to receive fuel from the second centrifugal pump of the main circuit.

20. An aircraft engine comprising:
the fuel control system of claim 16;
an accessory gearbox comprising a rotating element connected to at least one of the rotor portion of the first centrifugal pump and the rotor portion of the second centrifugal pump to drive the rotating element in rotation relative to at least one of the stator portion of the first centrifugal pump and the stator portion of the second centrifugal pump;
a rotating spool connected to the accessory gearbox to drive the rotating element in rotation; and
a combustion chamber comprising an injector connected to the discharge line of the main circuit to receive fuel from the second centrifugal pump of the main circuit.

21. An aircraft engine comprising:
the fuel control system of claim 17;
an accessory gearbox comprising a rotating element connected to at least one of the rotor portion of the first centrifugal pump and the rotor portion of the second centrifugal pump to drive the rotating element in rotation relative to at least one of the stator portion of the first centrifugal pump and the stator portion of the second centrifugal pump;
a rotating spool connected to the accessory gearbox to drive the rotating element in rotation; and
a combustion chamber comprising an injector connected to the discharge line of the main circuit to receive fuel from the second centrifugal pump of the main circuit.

22. An aircraft comprising the aircraft engine of claim 18.

23. An aircraft comprising the aircraft engine of claim 19.

24. An aircraft comprising the aircraft engine of claim 20.

25. An aircraft comprising the aircraft engine of claim 21.
